(19) United States
(12) Patent Application Publication
(10) Pub. No.: US 2014/0278580 A1
(43) Pub. Date: Sep. 18, 2014

(54) SYSTEMS AND METHODS FOR ACCOUNT PROCESSING

(71) Applicants: Merlin Brown, Minneapolis, MN (US); Arturo Solarte, Minneapolis, MN (US); Michael McDonald, Brooklyn Park, MN (US); Ross Ronnenberg, Plymouth, MN (US); Kathryn Miller Clayton, Savage, MN (US)

(72) Inventors: Merlin Brown, Minneapolis, MN (US); Arturo Solarte, Minneapolis, MN (US); Michael McDonald, Brooklyn Park, MN (US); Ross Ronnenberg, Plymouth, MN (US); Kathryn Miller Clayton, Savage, MN (US)

(21) Appl. No.: 14/209,803

(22) Filed: Mar. 13, 2014

Related U.S. Application Data
(60) Provisional application No. 61/782,242, filed on Mar. 14, 2013.

(51) Int. Cl. G06Q 40/08; G06Q 20/22; G06Q 20/40

(52) U.S. Cl. CPC G06Q 40/08; G06Q 20/227; G06Q 20/405
USPC 705/4

(57) ABSTRACT

Systems and methods for account processing are disclosed. In an example, the account processing systems and methods are used to process health care expenses for groups or individuals. Debit or credit transactions can be processed using a notional participant account. Processing a debit transaction can include identifying balances in one or more different portions of the notional participant account and allocating funds in an amount less than or equal to the one or more balances from the account to satisfy all or a portion of the debit transaction. When a balance remains in the debit transaction after allocating the funds, the method can include identifying a participant line-of-credit and allocating a remainder of the debit transaction using the line-of-credit.

### CLAIM OF PRIORITY

This application claims the benefit of priority under 35 U.S.C. §119(e) of U.S. Provisional Patent Application Ser. No. 61/782,242, filed on Mar. 14, 2013, which is herein incorporated by reference in its entirety.

### BACKGROUND

Insurance arrangements can include pooled resources that are held to insure against a risk of expenses incurred by one or more of the insured participants. The insured participants can include individuals, groups, business entities, or others. In a health insurance plan, insurers assess a health risk and expected health care expenses for an individual or group, and provide insurance products and pricing in accordance with the risk. Generally, health insurance is provided to individuals under an insurance agreement or contract that defines the terms of coverage. In many cases, benefits are received based on the type or source of care received.

Health insurance is offered by, among others, government agencies, private businesses, and not-for-profit entities. To be covered by a health insurance plan, an individual (and sometimes the individual's employer) can be required to pay the insurer in the form of a premium, such as monthly, annually, or at one or more other times. Some health insurance plans operate under a deductible and the insured participant is required to contribute an amount toward their care before the insurer will pay a portion. Deductibles can apply to, among other things, clinic visits, hospitalizations, or prescription drugs. Some health insurance plans offer a co-insurance benefit, for example, that requires the insured to contribute a fixed percentage of care costs. In some examples, a deductible and co-insurance apply to the same health insurance plan.

Health insurance plans generally include some exclusions or limitations, such as prohibitions on specified procedures or services. The insured may be required to pay out-of-pocket for care that is excluded or otherwise limited. Some health care plans are provided to particular groups of individuals. For example, Medicaid (a state-sponsored health insurer) provides health care for low-income children and families, and for people with disabilities. Medicare is a government health insurance plan for people age 65 or older, people under 65 with certain disabilities, and people with end-stage renal disease.

### Overview

Systems and methods for account processing are disclosed. In an example, the account processing systems and methods are used to process health care expenses for groups or individuals. Debit or credit transactions can be processed using one or more notional or other participant accounts. Processing a debit transaction can include identifying a transaction authorization limit, identifying a balance in one or more different portions of a notional participant account, and allocating funds in an amount less than or equal to the identified balances to satisfy all or a portion of the debit transaction. In some examples, when a balance remains in the debit transaction after allocating the funds from cash or incentive-based accounts, the method can include identifying a participant line-of-credit and allocating or satisfying a portion of the debit transaction using the line-of-credit.

The systems and methods described herein can provide a health care account processing solution that can (1) provide financial security when a participant experiences unexpected major medical expenses the participant may not otherwise be able to afford, (2) provide control of health care decisions to participants and providers, (3) reduce overhead and structural costs required to administer traditional health insurance plans, (4) reduce over-utilization and under-utilization of health care through a participant-controlled health care spending account that can optionally be coupled with a health and wellness program, such as a rewards-based wellness program, and (5) encourage provider competition through the use of cash based, point-of-sale payments and transparent consumer pricing. The systems and methods discussed herein describe, among other things, computer-implemented, rules-based systems for managing the health care accounting solution. In some examples, the rules-based systems can be applied to process transactions that are other than health care-related transactions.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of an integration platform in communication with a third party service.

FIG. 2 illustrates generally an example of a transaction flow between a third party service and an integration platform.

FIG. 3 illustrates generally an example of a transaction flow using a participant account hub in an integration platform.

FIG. 4 illustrates generally an example of a transaction flow using a contribution portal in an integration platform.

FIG. 5 illustrates generally an example of a plan control hub in communication with a participant account hub and a contribution portal.

FIG. 6 illustrates generally an example that includes transaction processing rules.

FIGS. 7A and 7B illustrate generally an example that includes debit transaction processing rules.

FIG. 8 illustrates generally an example that includes updating a bank card authorization limit.

FIGS. 9A and 9B illustrate generally an example that includes credit transaction processing rules.

FIG. 10 illustrates generally examples of account transactions that can be performed using one or more modules from an integration platform.

FIG. 11 illustrates generally examples of account transactions that can be performed using one or more modules from an integration platform.

FIG. 12 illustrates generally examples of account transactions that can be performed using one or more modules from an integration platform.

FIG. 13 illustrates generally examples of account transactions that can be performed using one or more modules from an integration platform.

### DETAILED DESCRIPTION

Systems and methods described herein can provide, among other things, a vehicle to aid participants and insurers in managing transactions and financial risks associated with health, wellness, and medical expenses. Participants can include one or more individuals who receive health coverage under an insurance plan. In some examples, participants can receive coverage under a plan as individuals or through an affiliation with a business, union, professional association, fraternal association, or other group. Among other benefits, the systems and methods described herein can provide consumer-oriented conveniences and efficiencies, such as a card-based payment system, and can encourage free market principles of price transparency and competition.

In an example, the systems and methods can be used to administer a health insurance plan. The health insurance plan can include rules that are used to determine whether and to what extent the insurer or the participant will pay various health care-related expenses. The systems and methods herein provide a Health Care Services Account (HCSA) that can include notional or other participant accounts that are accessible by a participant for health care-related expenses. In an example, a notional participant account can be accessed by the participant using, among other things, a credit card-like system. In some examples, the credit card-like system can use an existing credit card or transaction processing network, or infrastructure, to process transactions to or from one or more participant accounts.

Notional account transaction processing can include debiting or crediting a specified account balance, and can include accessing or allocating insurer-provided funds or other resources. The systems and methods provided herein can be used to receive or process transactions for notional participant accounts, and to optionally automatically select from one or more associated accounts to satisfy a transaction. For example, in response to initialization of a debit transaction, the systems and methods can be used to allocate funds from at least first and second accounts to satisfy or complete the debit transaction. In an example, the first account includes a cash-like account, and the second account includes one or more of a co-insurance or line-of-credit account. In some examples, transactions that involve one or more of the accounts of a specified type can be applied toward a participant deductible when the plan includes a deductible feature.

In an example, a Health Care Services Account (HCSA) is provided. The HCSA can be conceptually a bank account with specified rules that govern transactions into or out of the account. Transactions into the account can include deposits or credits, and transactions out of the account can include withdrawals or debits. In an example, and as further described below, the HCSA can provide advantages that include, but are not limited to, provider price transparency, health and wellness incentives that can be integrated with participant advocacy tools, cash payments to providers, such as without medical billing codes and without claims, and diminishing participant premiums, such as when a balance in one or more portions of the HCSA accrues over time or exceeds some threshold amount.

In an example, a cash-based payment system is provided that participants can use for many or all health care products or services, as specified under the plan. Providers can include, but are not limited to, caregivers, hospitals, vendors, and retailers. Providers can be paid at a point-of-sale, when a service is performed, or when care is rendered. Under the plan, when a provider initiates a transaction with a plan participant and the participant's HCSA, the provider can receive payment without submitting detailed claims and without waiting for subsequent reimbursement from an insurer or other entity.

In an example, payment is provided from the participant to a provider using a proprietary or plan-specific Benefits Card. From the provider's perspective, the Benefits Card can function similarly to a consumer credit card. That is, the Benefits Card itself can be a similar size and shape, and can include, among other things, participant identification information, including information about the participant or the participant's HCSA stored on or within the Benefits Card, such as magnetically or using an RF-enabled chip.

Although the term “Benefits Card” is used throughout this document, other physical or non-tangible items, such as can be functionally similar to a physical card, are considered to be included anywhere the term “Benefits Card” is used. For example, a Benefits Card can include a key fob, an RFID chip, a mobile computing device running a particular software program, or any other device that can store plan or participant identification information. In an example, a Benefits Card is a notional card or software certificate or token. A participant can use a unique identifier, such as a user name, optionally in combination with a password or personal identification number or code, to access plan features using software (e.g., using a mobile or other computer), and to perform transactions on-line.

In some examples, transactions performed using a Benefits Card are processed using existing bank card processing or payment networks (e.g., networks provided by Visa, or MasterCard, etc.). Because payment is made using the Benefits Card, and the participant-specific HCSA linked to the Benefits Card, a caregiver or vendor can immediately collect payment just as they would from a traditional credit card transaction. A provider's billing and bad-debt collection costs can thus be drastically reduced or eliminated because there is no need for claims to be coded and processed, and the traditional insurance overhead requirements related to approvals, quality, and managed care are eliminated.

In an example, the Benefits Card is linked to the participant HCSA, and the HCSA includes one or more accounts or portions of an account. The HCSA accounts can be notional accounts, or the HCSA accounts can be other types of accounts. The HCSA can include one or more of, among others, a cash-like account, a line-of-credit, an incentive account, a deductible, or a co-insurance account. The HCSA accounts or account portions can be funded by plan premiums, participant contributions, participant-earned credits, or other sources.

In an example, the HCSA is a virtual account that can be owned or maintained by an insurer or other administering entity. The HCSA can be a tax-qualified account that is accessible to participants through a Benefits Card, and can be used to pay for participant health care costs. In an example, some health care costs are not eligible for payment by the HCSA, such as determined by local or federal law governing the tax-qualified account.

In an example, the HCSA is used according to an integration platform, described below and shown in FIGS. 1-5. The integration platform can enable participant-level account and transaction settlement between the insurer and the participant's HCSA. That is, the integration platform can include a description or definition of rules that govern HCSA transactions.

In an example, the HCSA includes a first account or First Dollar account. The first account can include a cash-like account that can be similar or equivalent to a traditional savings or checking account, and can optionally be accessible by a participant using a traditional debit card or other means. In some examples, the first account is taxed differently than other types of accounts, or the first account includes a tax-exempt or tax-deferred account. In an example, the HCSA include one or more additional cash-like accounts. Contributions to or balances in the multiple different cash-like accounts can be subject to different contribution rules, limits, tax statuses, or other different parameters. For example, a Second Dollar account can include funds from a participant flexible spending account or health savings account.

In an example, the HCSA includes a second account that can be another type of account, such as an incentive account. The incentive account can be funded by, among other sources, a reward-based system that rewards participant enrollment or participation in health or wellness activities with deposits or credits to the incentive account. For example, an incentive account can receive funding in response to a participant's exercise activities (e.g., recorded and updated automatically using a participant mobile computing device), participation in health-related education programs, or other activities specified by the participant's plan. In an example, an integrated Health and Wellness Program can be provided to reward participants for desired outcomes. Rewards to participants can be provided in the form of cash or other contributions to the participant's HCSA. The incentive contributions can optionally be applied to accounts other than the incentive account, such as to one or more of the cash-like account, line-of-credit account, or other rewards-based account provided under the HCSA.

In an example, the HCSA includes a line-of-credit account. The line-of-credit account can be maintained by one or more of the plan administrator, insurer, or third party. A balance in the line-of-credit account can accrue interest. A credit limit or an interest rate can be established based on a participant, plan, or group-specific parameter. For example, an available credit limit can be influenced by a participant's personal credit score and can optionally be influenced by other plan features, such as a maximum out-of-pocket amount, a starting first account balance, or other factors. An interest rate associated with the line-of-credit account can be fixed, or variable, and can optionally be tied to one or more fluctuating indices.

When a participant uses a Benefits Card to access funds to complete a transaction with a provider, the funds can be withdrawn from one or more of the participant's HCSA accounts according to a plan-defined sequence or hierarchy. For example, funds can be initially withdrawn from a first, cash-like account. If a specified portion of the balance available in the first, cash-like account is exceeded by the transaction, other accounts, such as a line-of-credit account or incentive account, can be used to pay the remaining balance due.

In an example, the HCSA includes a back-end deductible whereby participant spending can be subject to a deductible before co-insurance, maximum participant out-of-pocket, or other insurance benefits take effect. The HCSA can include a line-of-credit to cover payments for health care products or services that exceed an available participant balance or insurer-provided balance. In an example, a participant can make payments to the line-of-credit, such as using future premium contributions, or using payments made directly into the line-of-credit account by the participant (e.g., using pre-tax or post-tax dollars, as available). In an example, the HCSA includes one or more account portions with a balance that can roll over from plan term to plan term if not used by the end of a plan term. For example, the HCSA can include a balance that can roll over each year when the plan term is one year.

In an example, if a participant grows a Health Care Services Account balance, such as by participant contributions or employer contributions to the account, the accumulated balance can enable pricing strategies and benefits that provide, for example, diminishing premiums for the employer, the employee, or both. That is, in some examples where the participant is an individual or family, a participant premium, such as paid by the participant or the participant's employer, can optionally be reduced as the participant's HCSA balance increases. In some examples, diminishing premiums can be applied on a group-wide basis. Diminishing premiums, such as optionally coupled with Health and Wellness Program incentives (further described below), can provide discounts for health care costs to participants who are healthy or who choose to be cost conscious with their use of health care benefits or with their selection of health care providers or services.

In addition, by reduced provider overhead expenses associated with bill processing and collection, some providers can reduce their fees or rates when a participant pays in cash. In an example, cash-based provider prices can be separate and different from contracted rates under a traditional insurance plan. Using cash-based provider pricing, consumers can make better-informed and cost-effective decisions about their individual health care choices.

Various systems and methods can be used to administer the HCSA, and to handle transactions into and out of participant or plan-owned accounts included in the HCSA. For example, an integration platform or third party banking services can be used to administer the HCSA and to handle transactions. Some of the examples described herein, including the integration platform and third party banking services, include logic or a number of components, modules, processors, or other mechanisms. As described herein, a module can include a processing layer or platform. Modules may constitute either software modules (e.g., code embodied (1) on a non-transitory machine-readable medium or (2) in a transmission signal) or hardware-implemented modules. A hardware-implemented module can include a tangible unit capable of performing certain operations and may be configured or arranged in a certain manner. In example embodiments, one or more computer systems (e.g., a standalone, target or server computer system) or one or more processors may be configured by software (e.g., an application or application portion) as a hardware-implemented module that operates to perform operations as described herein.

In some examples, a hardware-implemented module can be implemented mechanically or electronically. For example, a hardware-implemented module can include dedicated circuitry or logic that is permanently configured (e.g., as a special-purpose processor, such as a field programmable gate array (FPGA) or an application-specific integrated circuit (ASIC)) to perform certain operations. A hardware-implemented module can include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

As used herein, the term “hardware-implemented module” should be understood to encompass a tangible entity that can be physically constructed, permanently configured (e.g., hardwired) or temporarily or transitorily configured (e.g., programmed) to operate in a certain manner and/or to perform certain operations or transactions described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. For example, a general-purpose processor may be configured to instantiate functions of different components of the integration platform at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules can initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors can support performance of the relevant operations in a cloud computing environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Referring now to FIG. 1, an example of an integration platform 110 is provided. The integration platform 110 can be configured to exchange information with third party banking services 120. The integration platform 110 can include a module or processing layer, such as can be computer-implemented. The third party banking services 120 can include a module or processing layer, such as separate from or in communication with the integration platform 110. The third party banking services 120 can be computer-implemented.

In FIG. 1, a top level view is provided to show relationships between multiple platform module components. For example, third party banking services 120 can include a bank card processing platform 122, payment networks 124, and a merchant point-of-sale system 126. The integration platform 110 can be communicatively coupled with the bank card processing platform 122, such as to exchange information about HCSA transactions and plan rules. In an example, a participant account hub 112 includes systems and methods for allocating funds and managing HCSA balance(s). The participant account hub 112 can be linked to a plans control hub 114, such as to share information about one or more supported plans, and the participant account hub 112 can be linked to a contribution portal 116, such as to receive allocation information from, among other sources, premiums, payments, or other allowances.

In an example, the integration platform 110 can be accessed by a user or plan participant (hereinafter, “participant”) using the Benefits Card. For example, the Benefits Card can include information that can be interpreted by the third party banking services 120, and the third party banking services 120 can in turn exchange account or plan information with the integration platform 110. For example, the merchant point-of-sale system 126 can be configured to receive information from the Benefits Card and use the third party banking services 120 to exchange information with the integration platform 110 to process health care or other transactions. In an example, the integration platform 110 is configured to track all balances for one or more participants, such as across one or more notional or other accounts that are tied to a participant who can access the accounts using the Benefits Card. Allocations to or from the accounts can be processed according to a set of plan rules, such as participant-specific plan rules. In an example, a participant can prepay out-of-pocket or deductible amounts, similar to pretax contributions to a traditional flexible spending account (FSA) or health savings account (HSA). Generally, amounts that are prepaid by a plan are referred to herein as First Dollar amounts, such as including funds in a First Dollar account, and amounts that are prepaid by a participant are referred to herein as Second Dollar amounts, such as including funds in a Second Dollar account.

FIG. 2 is a block diagram illustrating generally example transaction flows between a third party services layer 120 and an integration platform 110. In an example, the integration platform 110 leverages third party banking services for processing payments (e.g., cash payments, or cash-like payments) to health care providers using funds (e.g., from premiums or other contributions) made available through notional (i.e. owned by an insurance plan) participant HCSAs. Some elements of the platform's use of third party banking services 120 are further defined in FIG. 2.

In an example, third party banking services are used for, among other things (1) flexibility to use multiple types of bank cards, optionally including a card that can be configured to access multiple different accounts according to specified plan terms, and (2) integration of banking services through the integration platform to enable participant-level account and transaction settlement between an insurance plan and a participant's HCSA. Various request and authorization pathways 201, 202 are illustrated in FIG. 2 to show generally an information exchange between merchant point-of-sale systems 126, payment networks 124, bank card processing platforms 122, and the participant account hub 112.

In an example, a transaction can include a transaction initiation event at the merchant point-of-sale system 126. At 210, a merchant, for example a health care services provider, can initiate the transaction, such as using a participant's Benefits Card and a card reader. The transaction can include a request for a credit or debit to the participant's account by submitting the participant's account information, such as identified using the Benefits Card, to the payment network 124. At 212, and using the payment network 124, a third party card servicer can evaluate whether the transaction is valid. The card servicer can include, among others, a bank or other issuer associated with the Benefits Card. Evaluating whether the transaction is valid can include, among other things, determining whether the Benefits Card information refers to a valid, available account, determining whether the merchant is approved to initiate a transaction with one or more of the available accounts, or determining if a substantiation of the Benefits Card is valid, for example, determining if a personal identification number or PIN submitted with the account information is valid. If the transaction is found to be invalid at 212, then the transaction can be declined and a notification can be returned to the merchant point-of-sale system 126. If the transaction is found to be valid at 212, then the transaction can continue to the bank card processing platform 122.

At 214, at the bank card processing platform 122, further authorization for the transaction can be provided. At 214, participant account balances can optionally be identified, such as including an incentive balance, a cash-like account balance, or a line-of-credit balance. In the case of a debit transaction, if the available balance is insufficient to perform the requested transaction, the transaction can be declined and notification of the declined transaction can be returned to the merchant point-of-sale system 126, such as by way of the payment network 124. If the available balance meets or exceeds the amount requested in the transaction, then a transaction authorization can be issued at 216. In an example, at 214, a bank card authorization limit (BCAL) for the Benefits Card can alternatively or additionally be identified and used to determine whether to accept or reject a transaction request, such as before identifying any other participant account information. For example, if the transaction amount is less than or equal to the BCAL, then the transaction can be authorized, and the transaction can be further processed using one or more of the bank card processing platform 122 or the participant account hub 112. If the transaction amount is greater than the BCAL, the transaction can be declined, and notification of the declined transaction can be returned to the merchant point-of-sale system 126, such as by way of the payment network 124.

At 218, the authorization can optionally be processed using the payment network 124, such as by updating a merchant account to reflect a corresponding credit or debit. At 220, the merchant point-of-sale system 126 can receive notification that the transaction was approved and completed.

At 230, the bank card processing platform 122 can exchange information with the integration platform 110 to update one or more participant account balances. Systems and methods for account balance updates using the integration platform 110 are further described below in the example of FIG. 3.

FIG. 3 is a block diagram illustrating generally example transaction flows between a participant account hub 112 and other aspects of the system. In an example, the participant account hub 112 integrates third party banking services 120 and the integration platform 110. The participant account hub 112 provides, among other things, (1) receipt of authorized participant health care transactions (charges/debits and corrections/credits), (2) allocation of those transactions based on the terms of the participant's health insurance plan and HCSA balance(s), and (3) updates to the participant's balance(s) via the bank card processing platform 122 (i.e., updates the participant's personal HCSA) to account for insurance plan terms such as deductibles, co-insurance obligations, and maximum out-of-pocket limits, among other considerations. Updating a participant balance using the bank card processing platform 122 can include updating a maximum transaction authorization amount, or a bank card authorization limit (BCAL) associated with a participant Benefits Card. In an example, the participant account hub 112 exchanges information with the plans control hub 114 to receive information about a participant's (or other's) plan, and exchanges information with a contribution portal 116.

In the example of FIG. 3, the bank card processing platform 122 can exchange information with the participant account hub 112, including information about transaction authorizations and participant account balance updates. In an example, at 302, information about a transaction authorized by the bank card processing platform 122 can be provided to the participant account hub 112. In an example, the information about the transaction can include information to identify the participant's account and to determine plan and participant parameters or options to apply to the transaction. In an example, the information can include transaction processing algorithms or rules that apply to the particular participant's plan and account. At 322, the plan and account-specific information can optionally be retrieved from the plans control hub 114. The plans control hub 114 can include a plan database that can include information about insurance plans, servicing, and participant options or parameters.

After the plan parameters and options are identified, such as at 302 and 322, transaction allocations can be performed using a rules-based payment or credit hierarchy at 304. In an example, the hierarchy can include an incentive account balance, a health care cash-like account balance, a line-of-credit account, a deductible balance, a co-insurance contribution, a participant out-of-pocket maximum, or carrier/plan costs or obligations. The hierarchy order can be specified according to plan terms, and the hierarchy order can be different for different participants.

At 306, the participant account hub 112 can generate a participant alert to report a transaction, such as to report a transaction amount or balance change in one or more different notional accounts. A participant alert or notification can be provided to a participant using, among other means, an SMS text message at 308, or an email message at 310.

At 312, the participant account hub 112 can be configured to generate a participant account debit or credit, and to update a balance at the bank card processing platform 122. Generating the debit or credit can include, at 314, maintaining participant and insurance plan records, or, at 316, initiating updates to a participant account or a BCAL on the bank card processing platform 122. In an example, at 314, maintaining the records can include using updated participant and plan balances from allocation rules or contributions to calculate changes to HCSA balances and/or a BCAL.

In an example, at 314, the participant account hub 112 can be configured to receive instructions or other information from the contribution portal 116. At 318, participant account balances can be updated using information from one or more contribution sources, such as participant payments, premiums, employer allowances, incentives, or other sources.

FIG. 4 is a block diagram illustrating generally example transaction flows in a contribution portal 116. In an example, an HCSA can be funded by contributions from multiple sources, including, among others, a portion of premiums paid by either employers (at 402) or individual participants (at 404), allowances provided by employers using self-insured plans (at 406), incentive payments from participation in health and wellness programs (at 408), or participant payments, such as when an HSCA line-of-credit is used (at 410). In an example, contributions can be allocated to one or more accounts controlled by the HCSA. For example, particular contributions can be applied to line-of-credit interest or principal balances, or contributions can be applied to a cash-like account balance or to an incentive account balance.

At 420, the contribution portal 116 can be configured to determine all plan and participant parameters and options to apply to the contributions from the multiple sources (at 402 through 410). For example, splits or divisions can be calculated, such as to determine what portion of a contribution is allocated to reserves, insurance payments, and to the participant HCSA. At 422, the contribution portal 116 can be configured to calculate an application of funds from allowances or other contribution sources to participant HCSA balances. The addition of funds to HCSA balances can be calculated using a rules-based, plan or participant-specific allocation hierarchy, such as including a line-of-credit interest portion, a line-of-credit principal portion, a health care balance, or an incentive balance. At 424, information from the calculations at 422 can be applied to maintain insurance plan and servicing master records.

In the example of FIG. 4, the plans control hub 114 can be configured to include or exchange information with a database having information about one or more participant plans. The plans control hub 114 can exchange information with the contribution portal 116, such as in determining the plan and participant parameters and options to apply to contributions at 420, or in administering the incentive contributions at 408. At 430, the participant account hub 112 can be configured to use information from the contribution portal 116 to maintain a participant record. Maintaining a participant record can include, at 432, updating one or more participant account balances, such as using the bank card processing platform 122, and updating a BCAL.

FIG. 5 is a block diagram illustrating generally an example of a plans control hub 114. In an example, the plans control hub 114 can implement and define new health care plans for groups (either fully-insured or self-insured groups) and participants, update plans as changes are rolled out for new enrollment periods, or create a consistent control point for the distribution or use of all parameters and options across the integration platform 110. That is, in some examples, the plans control hub 114 serves as a repository of plan information that corresponds to a particular participant or group of participants.

In the example of FIG. 5, the plans control hub 114 can use a hub platform interface 502 to exchange information with one or more of the participant account hub 112 and the contribution portal 116. The participant account hub 112 can be used to determine options and parameters governing processing of participant health care transactions, such as described above in the example of FIG. 3. The contribution portal 116 can be used to determine options and parameters governing processing of contributions, such as described above in the example of FIG. 4. The hub platform interface 502 in the plans control hub 114 can include or can be communicatively coupled to a database that can be configured to include insurance plan, servicing, and participant options and parameters, such as using the participant account hub 112 or the contribution portal 116.

The example of FIG. 5 can include a hub user interface 504. The hub user interface 504 can be configured to create and maintain one or more client plans. A client plan module is shown at 506. The client plan module 506 can include one or more modules 501, 503, 505, etc., that correspond to different groups of plans, such as a group of plans for an employer, a group of plans for a union, or a group of plans for individual participants. The hub user interface 504 can be configured to communicate with a health and wellness module 508, such as by way of the client plan module 506. For example, one or more parameters received from the client plan module 506 can be used to identify whether and to what extent the health and wellness module 508 is available to a particular group or individual. The parameters received from the client plan module 506 can further identify any benefits, rewards, or requirements associated with the health and wellness module 508. In an example, the hub platform interface 502 can exchange information with the client plan module 506.

At 510, the hub user interface can access communication options. The communication options can include rules or other parameters that determine how the hub user interface 504 shares information with plan participants or administrators. At 512, when the plan is administered at least in part by an employer, the communication options can include employer-related communication options, such as including options or information about enrollment, payroll contributions, or usage reporting, among other employer-related functions. At 514, the communication options can include participant-related communication options, such as including options or information about participant account statements, alerts, or Benefits Card options, among other participant-related functions.

The client plan module 506 can be configured to exchange information with a plan definition module 520. The plan definition module 520 can include one or more modules 521, 523, 525, etc., that correspond respectively to one or more of the modules in the client plan module 506. For example, a first plan definition module 521 can correspond to a first client plan module 501. The one or more modules 521, 523, 525, etc., in the plan definition module 520 can include information about distinct plans within a client plan module 506 such as respective risk owners, bank card and claims processing partners, covered costs, and other plan-specific information, such as corresponding to one or more participants as provided in the client plan module 506.

At 530, the plan definition module 520 can exchange information with a premium plan module 530 or an account option module 540. The premium plan module 530 can include one or more plan-specific modules corresponding to a particular plan definition module 520. The premium plan module 530 can include information about premiums to be contributed by one or more of an employer, employee, group, or information about a deductible, co-insurance, or maximum out-of-pocket amount for a particular plan definition module 520. The account option module 540 can include one or more plan-specific modules corresponding to a particular plan definition module 520. The account option module 540 can include information about types of available accounts for the particular plan definition module 520, such as including a cash-like account, an incentive account, an ancillary participant payment account (e.g., a second dollar account), or a line-of-credit account. The account option module 540 can include other information associated respectively with each available account type, such as rollover options on the cash-like account, contribution options on the ancillary participant payment account, or an interest rate for the line-of-credit account.

FIG. 6 illustrates generally an example 600 that includes processing a transaction using the participant account hub 112. The example 600 can include, at 610, receiving an approved transaction from the bank card processing platform 122 at the participant account hub 112. See, for example, the discussion of FIG. 2, above. Receiving the approved transaction at 610 can include receiving a data packet, at the participant account hub 112, the data packet including information about a transaction (such as initiated at a merchant point-of-sale system 126) that was approved. The transaction can be approved, for example, when the transaction amount is less than or equal to an available balance, and the available balance is determined using information from one or more participant or group accounts.

At 620, details about the transaction can be exchanged with the integration platform 110 using the participant account hub 112. The transaction details exchanged at 620 can include, among others, a transaction amount, or an available balance in one or more participant accounts, such as before or after the transaction is processed. At 630, the plans control hub 114 can be queried to determine plan or participant parameters to apply to the transaction. Querying the plans control hub 114 can include sending an information request from the participant account hub 112 to one or more databases included in the plans control hub 114. The requested information can be retrieved from a physical memory in or associated with the plans control hub 114, and the requested information can be returned to the participant account hub 112 for further processing. In an example, the requested information can include allocation or transaction processing rules that are available to be applied to the transaction.

At 640, the type of transaction can be assessed. In an example, the type of transaction can be identified as one of a credit or debit type of transaction. When the transaction type is determined to be a debit transaction, debit transaction processing rules can be applied at 650. An example of debit transaction processing rules is provided in FIGS. 7A and 7B. When the transaction type is determined to be a credit transaction, credit transaction processing rules can be applied at 660. An example of credit transaction processing rules is provided in FIG. 8.

FIGS. 7A and 7B illustrate generally an example 700 that can include debit transaction processing rules, such as can be performed out using one or more of the product integration platform 110 and the third party banking services 120. The debit transaction processing rules can be applied using one or more processor circuits, such as corresponding to one or more servers, databases, or processor circuits in the integration platform 110. At 710, the example 700 can include allocating an available incentive balance to satisfy all or a portion of the debit transaction amount. In some examples, an incentive balance may be unavailable or may be zero; in some examples, the incentive balance may be sufficient to satisfy the entire debit transaction; in some examples, the incentive balance may satisfy a portion of the debit transaction. At 711, the transaction is assessed, such as after allocating the incentive balance, to determine whether the debit is satisfied or paid in full. If the debit is paid in full by using all or a portion of the incentive balance, then the example 700 continues at 760, below. If the debit is not paid in full using the incentive balance, then the example 700 continues at 720.

At 720, an available health care allowance balance can be allocated to satisfy at least a portion of the remaining debit transaction amount. The available health care allowance balance can include, for example, funds from a portion of a participant HCSA, such as a first dollar coverage account or a cash-like account. In an example, the health care allowance balance can be funded by, among other sources, participant contributions or plan premiums, such as paid by an employer. At 721, the transaction is assessed to determine whether the debit is satisfied or paid in full. If the debit is paid in full by using all or a portion of the available health care allowance balance, then the example 700 continues at 760, below. If the debit is not paid in full using the available health care allowance balance, then the example 700 continues at 723.

At 723, the transaction and the plan are assessed to determine whether the participant-paid deductible balance is less than the plan term maximum. That is, at 723, the transaction and the plan are assessed to determine whether the deductible was already met or exceeded by the participant in the current plan period. If the deductible balance is less than the term maximum, then, at 730, the transaction amount can be allocated to the deductible, such as up to the term maximum. The amount allocated to the deductible can be funded from ancillary payment account balances, if any are available, and then from line of credit balances. After allocating the appropriate amount to the deductible balance, the transaction can be assessed at 731 to determine whether the debit is satisfied or paid in full. If the debit is paid in full, then the example 700 continues at 760, below. If the debit is not paid in full, or if the deductible balance is equal to the term maximum (at 723), then, at 733, the participant out-of-pocket expenses can be analyzed.

At 733, the transaction and the plan can be assessed to determine whether a participant-paid out-of-pocket balance is less than a term maximum. That is, a participant's out-of-pocket expenses can be compared to an out-of-pocket maximum that is determined according to the participant's plan parameters. If the participant's out-of-pocket balance is less than the term maximum, then, at 740, any remaining amount of the transaction can be allocated using plan co-insurance parameters, if available under the participant's plan. A participant's co-insurance amount up to the term out-of-pocket maximum can be paid by the participant to satisfy the debit transaction. At 740, a participant co-insurance amount can be funded from any ancillary account balances, such as a second dollar account, or from a participant line-of-credit account. At 750, any remaining balance can be allocated to an insurance plan health care cost account, that is, the remaining balance can be funded by the health insurer. At 733, if the participant's out-of-pocket balance is greater than or equal to the term maximum, then the remaining balance can be allocated to the insurance plan health care cost account at 750. From 750, the example 700 can continue at 760.

At 760, an alert can be optionally be generated and provided to the plan participant, or to some other entity associated with the plan or participant. For example, at 760, an alert can be generated that can include information about the transaction debit, and can optionally include information about one of more of the account balances associated with the participant. In an example, the alert can be provided to the participant (or other entity) via SMS text message, email, telephone notification, physical mail, or other means of communicating the information.

At 770, the example 700 continues by calculating any updates for one or more of the participant Benefits Card balances. An example of a method for calculating the updates is provided in FIG. 8. Once the updates, if any, are calculated, the example 700 can include, at 780, submitting update transactions using the integration platform 110 and the bank card processing platform 122. At 790, the bank card processing platform 122 can perform the update transactions.

FIG. 8 illustrates generally an example 800 that can include calculating an update for a participant Benefits Card balance, such as can be performed using one or more of the product integration platform 110 and the third party banking services 120. The example 700 can optionally include one or more parts or portions of the example 800, such as at 770.

In the example of FIG. 8, at 810, credits or debits can be generated for a portion of a transaction that is paid by the health insurance plan. If a transaction includes a portion that is paid by the health insurance plan, then a bank card authorization limit (BCAL) can be updated at 820.

Updating the BCAL can include, at 821, determining whether a remaining participant out-of-pocket maximum is less than or equal to the participant available balance (PAB). The PAB is the sum of the participant's available incentive balance and the available health care allowance, plus any available ancillary payment account balance and any remaining line of credit balance. If the remaining participant out-of-pocket maximum is less than or equal to the PAB, then (1) the BCAL can be updated at 830 to be equal to the plan maximum transaction authorization limit, and (2) the example 800 can continue at 880 by submitting the update transactions using the integration platform 110 and the bank card processing platform 122. If the remaining participant out-of-pocket maximum is greater than the PAB, then the example 800 continues at 823.

At 823, the example 800 can include determining whether a remaining deductible is greater than or equal to a remaining line-of-credit amount. If the remaining deductible is greater than or equal to the remaining LOC amount (LOC_{REMAINING}), then the BACL is updated at 840 to be equal to the PAB. If the remaining deductible (DED_{REMAINING}) is less than the remaining LOC amount, then the BCAL is updated at 850, and then the example 800 continues at 880. At 850, BCAL can be updated according to Equation 1:

$$BCAL = PAB + \frac{{LOC}_{REMAINING} - {DED}_{REMAINING}}{1 - plan co \text{-} insurance \%} - ( {LOC}_{REMAINING} - {DED}_{REMAINING} ) \qquad ( Equation 1 )$$

FIGS. 9A and 9B illustrate generally an example 900 that can include credit transaction processing rules, such as can be performed using one or more of the product integration platform 110 and the third party banking services 120. The credit transaction processing rules can be applied using one or more processor circuits, such as corresponding to one or more servers, databases, or processor circuits in the integration platform 110. At 901, the example 900 can include determining whether the credit transaction is for a participant payment to a line-of-credit. If the credit transaction is for a payment to the LOC, then the credit amount can be allocated to the participant LOC at 910. If the credit transaction is not for a payment to the LOC, then other processing rules can be applied in the example 900 to determine how the credit is allocated to one or more of the participant's accounts.

At 903, the example 900 can include determining whether the participant has met an out-of-pocket maximum under the participant's plan. If the out-of-pocket maximum was met, then the credit transaction can be allocated to plan payments that were made after the maximum out-of-pocket amount was reached by the participant, such as payments made by the insurer or plan administrator.

After allocating the credit at 920, the credit transaction can be assessed at 921 to determine whether the credit transaction was fully allocated. If the transaction was fully allocated at 920, then the example 900 continues at 960. If the transaction was not fully allocated at 920, then the example 900 continues at 923.

At 923, the credit transaction can be assessed to determine whether any co-insurance amounts were paid by the participant. If any co-insurance amounts were paid by the participant, then, at 930, a credit is allocated to the participant account in an amount up to the total of all co-insurance payments made by both the participant and the plan. The allocation can be provided to the participant and the plan provider using the same co-insurance percentage that was used to fulfill the earlier debit under the co-insurance. The co-insurance credit allocated to the participant can be correspondingly allocated to the participant LOC or other accounts used to pay their co-insurance. At 931, the credit transaction can be assessed to determine whether the transaction was fully allocated at 930. If the transaction was fully allocated at 930, then the example 900 continues at 960. If the transaction was not fully allocated at 930, then the example 900 continues at 933.

At 933, the credit transaction can be assessed to determine whether a deductible amount paid by the participant is greater than zero. If the deductible amount paid by the participant is greater than zero, then the credit transaction can be allocated to the paid-deductible balance, such as up to the participant's paid-deductible total. The credit amount can be correspondingly allocated to the participant LOC account or other account that was used to pay the deductible. The example 900 can continue at 941 to determine whether the credit transaction was fully allocated. If the transaction was fully allocated at 940, then the example 900 continues at 960. If the transaction was not fully allocated at 940, then the example 900 continues at 950. At 950, any remaining amount of the credit transaction can be allocated to the participant's health care account allowance balance, such as by making a contribution to a first dollar or cash-like account, and the example 900 can continue at 960.

At 960, an alert can be optionally be generated and provided to the plan participant, or to some other entity associated with the plan or participant. For example, at 960, an alert can be generated that can include information about the transaction debit, and can optionally include information about one of more of the account balances associated with the participant. In an example, the alert can be provided to the participant (or other entity) via SMS text message, email, telephone notification, physical mail, or other means of communicating the information.

At 970, the example 900 continues by calculating any updates for one or more of the participant Benefits Card balances. An example of a method for calculating the updates is provided in FIG. 8. Once the updates, if any, are calculated, the example 900 can include, at 980, submitting update transactions using the integration platform 110 and the bank card processing platform 122. At 990, the bank card processing platform 122 can perform the update transactions.

FIG. 10 illustrates generally several examples of account transactions that can be processed using, for example, the integration platform 110 and the third party banking services 120. In the examples of FIG. 10, various participant accounts, or portions of a participant HCSA, are shown in columns. Transaction events are shown horizontally in different rows. In the examples of FIG. 10, an order in which a transaction debits from the various accounts can follow from the left-most column to the right. For example, a debit transaction can first draw from a first portion of an HCSA, such as a cash-like Health Care Allowance account and, when the Health Care Allowance balance is exhausted, the debit transaction can draw from the Incentive Balance. In an example, the Health Care Allowance account can be a first dollar, cash-like account, such as can be funded by the insurer (e.g., using premium dollars). In an example, the Health Care Allowance account can include a second dollar, cash-like account, such as can be funded by the participant.

The order in which transaction debits or credits occur can be plan specific. That is, the account debit or credit sequence can be different for different participants using different plans or different types of accounts. For example, in FIGS. 7A and 7B, an incentive balance can be allocated to satisfy a debit transaction before funds from other available account balances are allocated.

Different plans can have different account maximums, for example, an incentive account balance maximum can differ according to the plan. In some examples, one or more accounts can include a notional, point-based system, and a conversion between transaction dollars and points can be other than one-to-one. For example, an incentive account can include a point-based notional account, and participants can accrue points instead of dollars or other currency. The points can be redeemed for dollars or transaction credit when a debit transaction is processed.

At 1010, Example 1 illustrates a first transaction scenario, such as occurring as a first transaction in a participant's plan term. At 1011, starting balances for the different portions of the HCSA are provided. At 1012, Example 1 includes an approved debit transaction for $1,500. The debit transaction can be, for example, a provider debit, such as initiated by a provider's merchant point-of-sale system 126, and communicated to the participant account hub 112 using various payment networks and bank card processing platforms. From the provider's perspective, the entire $1,500 transaction is completed and the participant's debt is fully satisfied as soon as the provider's merchant point-of-sale system 126 receives an indication from the payment network 124 that the transaction was approved. There are optionally no codes or claims to process by the provider, an insurer, or the participant.

In Example 1, the debit transaction can be settled by first allocating $1,000 from the participant's “Health Care Allowance” portion of the participant's HCSA. The participant's available Incentive Balance can be applied next ($200), and the participant's available line-of-credit can then be tapped to satisfy the remaining balance ($300). After the debit transaction is processed, the participant's accounts are updated to reflect the new respective account balances, and an alert or notification is optionally provided to the participant, or to a plan administrator, or other entity elected by the participant to receive such notification.

In Example 1, the portion of the transaction that exceeds the available Health Care Allowance and Incentive Balances can be deducted from the participant's line-of-credit account. The participant can be required to contribute payments to the line-of-credit account in intervals defined by the plan terms. The amount deducted from the participant's line-of-credit can be applied to the participant's deductible and added to a running total of the participant's maximum out-of-pocket (e.g., for the plan term) expenditures. Thus, in Example 1, since $300 was deducted from the participant's line-of-credit account to satisfy the debit transaction, $300 was applied to the annual deductible, and $300 was further applied to the record of maximum out-of-pocket expenditures for the participant.

Example 2, at 1020, illustrates generally an example of a credit or refund transaction. Beginning with the ending balances from Example 1, Example 2 includes a credit of $1000. A first portion of the credit is applied first to the $300 paid deductible balance and the maximum out-of-pocket balance, and is credited to the line-of-credit account. The remaining $700 can be applied to the Health Care Allowance account. In Example 2, the Incentive Balance may not be credited, such as according to the plan rules and terms. In some examples, an Incentive Balance must be earned by a plan participant, such as by participating in various health and wellness activities. Accordingly, the funds from such accounts cannot be refunded or credited and, instead, the credit passes through to the Health Care Allowance account.

Example 3, at 1030, illustrates generally an example of a debit transaction. Beginning with the ending balances from Example 2, Example 3 includes a debit transaction of $4000. A first portion of the debit is allocated first from the Health Care Allowance account. Since only $700 were in the Health Care Allowance account when the debit was transacted, the Health Care Allowance account is exhausted. An amount up to the deductible is deducted next from the line-of-credit account. Once the deductible is met, the co-insurance benefit will apply, such as up to the plan-specified maximum out-of-pocket ($4000, in the example of FIG. 10). Because $1300 remains after the deductions from the Health Care Allowance account and line-of-credit (to meet the $2000 deductible), the $1300 remaining balance is subject to the co-insurance split. In Example 3, the co-insurance is applied at 50%; accordingly, the participant is responsible for 50% of the remaining $1300, and $650 is deducted from the participant line-of-credit. In Example 3, the plan or insurer thus contributed $650 to satisfy the remainder of the debit transaction.

Example 4, at 1040, illustrates generally an example of a debit transaction. Beginning with the ending balances from Example 3, Example 4 includes a debit transaction of $3000. In Example 4, the participant has already met the $2000 deductible, and at least a portion of the debit transaction is subject to the co-insurance benefit. However, in Example 4, the plan includes a maximum out-of-pocket benefit of $4000. To satisfy the $3000 debit transaction, the available line-of-credit is exhausted, the maximum out-of-pocket amount is reached, and the remainder is paid by the plan or insurer. The participant will then carry the $4000 balance on the line-of-credit until the participant pays down the principal of the line-of-credit. In the interim, the line-of-credit may be subject to a periodic finance charge that will increase the participant's liability over time. In an example, the finance charges are based on a fixed or variable rate as provided in the plan rules or parameters.

FIG. 11 illustrates generally several examples of account transactions that can be processed using, for example, the integration platform 110 and the third party banking services 120. As in FIG. 10, the examples of FIG. 11 include various accounts illustrated in different vertical columns, and transaction events illustrated in different rows. In the examples of FIG. 11, an order in which a transaction credit is processed or refunded into the various accounts can follow from the right-most column to the left. For example, a credit transaction can first satisfy an interest accrual corresponding to a line-of-credit account, then the credit transaction can satisfy a line-of-credit principal, and so on. The order in which transaction debits or credits occur can be plan specific, as described above.

At 1110, Example 5 illustrates a transaction that includes a credit to an Incentive Balance. In Example 5, even though the participant is carrying a line-of-credit balance and is accruing interest on that balance, the Incentive Balance can be credited first. In an example, the Incentive Balance credit can be received in response to the participant's participation in a wellness initiative.

At 1120, Example 6 illustrates a transaction that includes a participant payment of $200 to the line-of-credit. The payment can be applied first to the interest portion of the line-of-credit account, and then to the balance or principal portion of the line-of-credit account.

At 1130, Example 7 illustrates a transaction that includes a Health Care Allowance contribution of $1000. In an example, the Health Care Allowance contribution can be from a plan administrator, an insurer, an employer, the participant, or other source. In Example 7, the Health Care Allowance contribution can be deposited directly into the Health Care Allowance account, bypassing the remaining principal amount in the line-of-credit account, such as according to the plan rules.

FIG. 12 illustrates generally an example 1200 that includes multiple transaction examples applied to a particular example plan. In the example 1200, the maximum participant line-of-credit is equal to the participant maximum out-of-pocket. The maximum out-of-pocket in this example is $3000, including a $1000 deductible and $2000 that is subject to a co-insurance benefit. The example 1200 does not include a second dollar coverage account. In the example 1200, a maximum transaction authorization amount is $10,000. The maximum transaction authorization amount can be a fixed or fluctuating amount. In some examples, the maximum transaction authorization amount is determined at a plan level for all participants by a plan administrator, such as based on an assessment of potential transaction risks or other factors.

As in the examples of FIGS. 10 and 11, multiple different accounts or account types or features can be provided in the participant HCSA in the example of FIG. 12. For example, in FIG. 12, the HCSA includes an Incentive Account, a First Dollar Account, a Deductible, a Co-insurance benefit, and a Plan Co-insurance. Funding accounts for the HCSA can include a Participant Line-of-Credit, or a Plan Account. The HCSA and funding accounts can be maintained by the integration platform 110. Third party banking services 120 can be configured to use information from the integration platform 110, as described above, for example to use information about a cash-like account, an available line-of-credit, and a bank card authorization limit (BCAL) to electronically process transactions in accordance with plan requirements. The initial values of the various accounts are illustrated at row 1210. Since the participant's available LOC equals their maximum out-of-pocket obligation in this example, the BCAL is set to the plan maximum authorization amount of $10,000.

A first transaction, at 1220, can include a debit for $500. The debit request can be first checked against the BCAL, for example using the third party banking services 120, to see if the debit can be processed. Because the first transaction debit amount is less than the BCAL, the transaction can proceed and the bank card processor deducts this amount from the participant's bank card balances. The debit amount is less than an available balance in the First Dollar Account, and the debit can be satisfied using funds from the First Dollar Account. The First Dollar account optionally includes a cash-like account that is not subject to the plan deductible. Once the debit transaction is allocated to the appropriate balances, the BCAL is recalculated for the participant and, in this example, since the participant's LOC is equal to the maximum-out-of-pocket amount, a $500 adjustment is made to the bank card account to set the BCAL to the plan maximum authorization amount of $10,000.

A second transaction, at 1230, can include a plan incentive contribution for $100. The plan incentive contribution at 1230 can be applied to the Incentive Balance portion of the HCSA, and the integration platform can add this $100 to the participant's bank card account balance. Once this contribution is added to the account balances as shown, the participant's BCAL is recalculated and a $100 adjustment is made to the bank card authorization amount to keep it as the plan maximum authorization amount of $10,000.

A third transaction, at 1240, can include a debit for $1000. Since this amount is less than the BCAL, the transaction is authorized by the bank card processor, deducted from the bank card balances, and sent to the integration platform for processing. The debit can be processed and satisfied using one or more accounts in the HCSA, such as according to a plan-defined account priority sequence. For example, the debit can be processed using the method of the example 700. In the example of FIG. 12, the third transaction can be satisfied using funds from the Incentive Balance ($100), funds from the First Dollar account ($500), and funds from the participant's deductible, paid out of the participant's line-of-credit ($400). The participant's deductible payment is also added to the participant's maximum out-of-pocket amount for a specified plan term. To complete this transaction, the participant's BCAL is recalculated and, in this example, an adjustment of $1000 is made to reset the authorization amount back to the plan maximum transaction authorization limit of $10,000.

At 1250, a fourth transaction can include a debit for $2000. The debit can be processed and satisfied using the same or different accounts as in the third transaction, such as according to the plan terms and the available funds. Since the Incentive Balance and First Dollar accounts are exhausted, the participant's line-of-credit account can be used to fund the deductible and co-insurance out-of-pocket amounts. In the fourth transaction, the deductible is exhausted after the first $600. The co-insurance percentage, 50% in this example, applies to the remaining $1400 in the debit transaction, and the $700 participant responsibility can be provided, for example, using the participant line-of-credit account. To complete this transaction, the participant's BCAL is recalculated and a credit of $700 to the bank card account balance for the plan's co-insurance payment and an adjustment of $1300 is made to set the authorization amount to the plan maximum transaction limit of $10,000.

At 1260, a fifth transaction can include a credit for $2600. In this example, the bank card processor authorizes the credit, adds this amount on to the participant's bank card balances, and sends the credit to the integration platform for processing. The credit can be processed and one or more accounts in the HCSA can receive funds, such as according to a plan-defined account priority sequence. For example, the credit can be processed using the method of the example 900. In the example of FIG. 12, the fifth transaction can be processed by applying the credit first to any portion already paid using the co-insurance benefit, then to portions paid and subject to the deductible, and any remaining amount can be deposited or credited to the First Dollar account. To complete this transaction, the participant's BCAL is recalculated and a debit of $700 is made to the participant's bank card account balance for repayment of the plan's co-insurance payment. An adjustment of $1900 is made to reset the authorization amount to the plan maximum transaction limit of $10,000.

FIG. 13 illustrates generally an example 1300 that includes multiple transaction examples applied according to a set of rules under a particular example plan. In the example 1300, the maximum participant line-of-credit is less than a sum of the participant maximum out-of-pocket and a beginning balance in a Second Dollar account. Accordingly, the participant's BCAL is not reset to the plan maximum transaction authorization limit of $10,000, and instead the BCAL fluctuates according to an actual balance in one or more of the participant's accounts. The Second Dollar account can include a cash-like account with funds that are paid by the participant.

In the example 1300, the maximum out-of-pocket is $3000, including a $1000 deductible and $2000 that is subject to a co-insurance benefit. In the example 1300, the beginning balance in the second dollar account is $1300, and the participant line-of-credit is $1200. Since the participant's balances available to pay for their out-of-pocket obligations are less than the maximum plan out-of-pocket limit ($2500 versus $3000), the BCAL is calculated to be $5000 and the plan maximum transaction authorization amount of $10,000 will not apply to this participant.

At 1320, a first transaction can include a debit for $500. As in the example of FIG. 12 at 1220, the debit request can be first checked against the BCAL, for example using the third party banking services 120, to see if the debit can be processed. Because the first transaction debit amount is less than the BCAL, the transaction is authorized, the amount is deducted from the participant's bank card account balances, and the transaction is sent to the integration platform for processing. The debit amount is less than an available balance in the First Dollar Account, and the debit can be satisfied using funds from the First Dollar Account. The First Dollar account optionally includes a cash-like account that is not subject to the plan deductible. In the example of FIG. 13, the transaction is completed by recalculating the BCAL. In this example, the BCAL does not require an adjustment to the bank card balances since the first debit amount of $500 reduced the participant's available balances and their new authorization limit.

A second transaction, at 1330, can include a plan incentive contribution for $100. The plan incentive contribution at 1330 can be applied to the Incentive Balance portion of the HCSA. To complete processing of this transaction, the integration platform adds $100 to the bank card balance, the BCAL is recalculated based on the participant's available balances, and no adjustments are needed to reflect the incentive contribution.

A third transaction, at 1340, can include a debit for $1000. Because the transaction amount is less than the BCAL, the bank card processor can authorize the transaction, deduct $1000 from the participant's bank card balances, and send the transaction to the integration platform for processing. The debit can be processed and satisfied using one or more accounts in the HCSA, such as according to a plan-defined account priority sequence. For example, the debit can be processed using the method of the example 700.

In the example of FIG. 13, the third transaction can be satisfied using funds from the Incentive Balance ($100), funds from the First Dollar account ($500), and the balance being applied against the participant's deductible using funds from the Second Dollar account ($400). The participant's maximum out-of-pocket balance is also updated to reflect this deductible payment. To complete processing of this transaction, the BCAL is recalculated.

At 1350, a fourth transaction can include a debit for $2000. Since the transaction amount is less than the participant's BCAL, the bank card processor authorized the transaction, deducts $2000 from the participant's bank card balances, and sends the transaction to the integration platform for processing. The debit can be processed and satisfied using the same or different accounts as in the third transaction, such as according to the plan terms and the available funds. Since the Incentive Balance and First Dollar accounts are exhausted, the participant's Second Dollar account and line-of-credit account can be used to provide the required funds. In the fourth transaction, the example shows that the participant's out-of-pocket obligations are determined by first allocating the transaction to the remaining deductible, which is $600 in this case, and then splitting the remaining balance based on the plan co-insurance percentage. The co-insurance percentage of 50% in this example is applied to the remaining $1400 in the debit transaction, which results in a participant out-of-pocket obligation for this transaction of $1300 ($600 for the deductible and $700 for the participant's co-insurance responsibility). The participant's obligation in this example is funded by a balance in the Second Dollar account ($900), and then from the participant line-of-credit account ($400). To complete processing of this transaction, the integration platform credits the participant's bank card balances for the plan's portion of the co-insurance payment ($700), and recalculates the BCAL.

At 1360, a fifth transaction can include a debit for $1600. Because the transaction amount is less than or equal to the BCAL, the debit can be authorized, deducted from the participant's bank card balances, and sent to the integration platform for processing. Since the participant's Incentive and First Dollar account balances are exhausted, and since the participant has paid their maximum deductible, the plan's 50% co-insurance percentage is applied to the transaction and the participant's portion of the transaction ($800) is paid from the line-of-credit account. This amount is then added to the participant's maximum out-of-pocket balance. To complete processing of this transaction, the integration platform credits the participant's bank card balances for the plan's portion of the co-insurance payment ($800), and recalculates the BCAL.

At 1370, a sixth transaction can include a credit for $1200. The bank card processor authorizes the credit, adds the amount to the participant's bank card balances, and sends the credit to the integration platform for processing. The transaction can be processed by the integration platform according to a plan-defined account priority sequence. For example, the credit can be processed using the method of the example 900. In the example of FIG. 13, the sixth transaction can be processed by allocating the credit amount based on the co-insurance percentage (50%), applying the credit to plan and participant co-insurance payment balances, and crediting the participant's portion of the transaction ($600) to the account used to pay the co-insurance (in this example, a credit to the participant's line-of-credit). To complete processing of this transaction, the integration platform debits the participant's bank card balances for the portion of the credit that applies to the plan co-insurance payment, and recalculates the BCAL.

The preceding numerical examples, such as in the examples of FIGS. 10-13, are intended to be non-limiting and non-exhaustive. The examples are presented for illustrative purposes only. The present inventors contemplate other examples using any combination or permutation of the elements shown or described (or one or more aspects or variants thereof), either with respect to a particular example (or one or more aspects thereof), or with respect to other examples (or one or more aspects thereof) shown or described herein.

In an example, an HCSA is provided alongside a traditional health insurance plan that is configured to provide a plan participant with coverage for major medical expenses like hospitalizations, surgeries, or other medical expenses such as exceeding a particular dollar amount. That is, for some qualified events (e.g., defined by the insurer in the plan contract with the participant), the participant's HCSA would be unused, or only partially used, and a traditional health insurance plan (e.g., involving a deductible, co-insurance, or other coverage) can be applied to cover such major expenses. In some examples, the same plan coverage and terms provided using the integration platform 110 can be applied to cover expenses for a major medical event, such as in addition to or instead of a traditional health insurance plan.

Thus, systems and methods to provide account processing using multiple different notional accounts has been described. Although embodiments have been described with reference to specific transaction examples and embodiments, it will be evident that various modifications and changes may be made to these embodiments without departing from the broader spirit and scope of the inventive subject matter. Accordingly, the specification and drawings are to be regarded in an illustrative rather than a restrictive sense.

### Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method comprising:
providing a notional participant account using an integration platform module; and
processing a debit transaction for a first transaction amount using the notional participant account and at least one of the integration platform module or a third party services module, the processing the debit transaction including:
identifying an initial transaction authorization limit and, when the first transaction amount is less than or equal to the initial transaction authorization limit:
identifying a first balance in a first portion of the notional participant account and allocating first funds in an amount less than or equal to the identified first balance from the first portion of the notional participant account to satisfy all or a portion of the debit transaction;
when a balance remains in the debit transaction after allocating the first funds, identifying a second balance in one or more other portions of the notional participant account and allocating second funds in an amount less than or equal to the identified second balance from the one or more other portions of the notional participant account to satisfy all or a portion of the remaining debit transaction; and
when a balance remains in the debit transaction after allocating the first and second funds, identifying a participant line-of-credit and allocating the remainder of the debit transaction using all or a portion of the identified line of credit up to a first participant line-of-credit threshold.

2. The method of claim 1, wherein the allocating the remainder of the debit transaction using all or a portion of the identified line of credit up to a participant line-of-credit maximum includes contributing an insurer-provided plan amount to satisfy a portion of the debit transaction.

3. The method of claim 2, wherein the allocating the remainder of the debit transaction includes contributing an insurer-provided plan amount that is less than or equal to the amount allocated to the participant line-of-credit.

4. The method of claim 3, wherein the contributing the insurer-provided plan amount includes determining and contributing a co-insurance benefit amount.

5. The method of claim 1, wherein identifying the balance in the first account includes identifying a cash balance in the notional participant account.

6. The method of claim 1, wherein the identifying the first balance or identifying the second balance includes identifying a non-cash incentive balance in an incentive account portion of the notional participant account.

7. The method of claim 1, wherein the allocating the first or second funds includes updating a participant deductible or a participant maximum out-of-pocket.

8. The method of claim 1, further comprising processing a subsequent debit transaction using the notional participant account and the one of the integration platform or the third party services module, including identifying a different transaction authorization limit that is less than the initial transaction authorization limit.

9. The method of claim 1, wherein the identifying the initial transaction authorization limit includes using a bank card processing platform module to request the initial transaction authorization limit amount from the integration platform module.

10. A system for processing account transactions, the system comprising:
a participant account module configured to access one or more databases that include information about multiple notional participant accounts, the participant accounts corresponding respectively to multiple participants, and the participant accounts accessible using respective participant-specific banking cards; and
a third party banking services module including a payment network module and a bank card processing module;
wherein the payment network module is configured to receive a transaction request from a point-of-sale system; and
wherein the bank card processing module is configured to authorize or decline the transaction request using information from the participant account module about one or more of the multiple notional participant accounts.

11. The system of claim 10, further comprising a plans control hub module communicatively coupled to the participant account module, the plans control hub module comprising a participant-specific transaction rule engine that is configured to execute or to provide instructions to execute a balance update for one or more of the multiple notional participant accounts.

12. The system of claim 11, wherein the plans control hub comprises a non-transitory memory circuit that includes a database, the database including plan-specific transaction rules that can be used to perform transactions with the multiple notional participant accounts.

13. The system of claim 10, further comprising a processor circuit that is configured to retrieve a transaction rule, corresponding to a specified plan or participant, from a plans control hub module, and the processor circuit is configured to apply the transaction rule to perform a debit or credit transaction using at least one of the notional participant accounts.

14. The system of claim 10, wherein at least one of the participant account module or the third party banking services module is configured to determine a bank card authorization limit corresponding to a specified participant, the bank card authorization limit based in part on one or more notional account balances corresponding to the specified participant.

15. The system of claim 10, wherein the participant account module includes a contribution portal module, and the contribution portal module is configured to receive an allocation into one or more of the notional participant accounts according to a plan-specific transaction rule.

16. A tangible, non-transitory processor-readable medium comprising instructions that, when executed by a processor circuit, cause the processor circuit to perform operations comprising:
identify a transaction type;
determine, using information from a plans control hub module, a participant-specific plan parameter corresponding to the identified transaction type;
apply a rules-based allocation of participant or plan resources to satisfy the transaction, the rules-based allocation based on the determined participant-specific plan parameter; and
update a participant notional account using the rules-based allocation.

17. The processor-readable medium of claim 16, comprising instructions that cause the processor circuit to identify a transaction authorization limit when the identified transaction type is a debit transaction type.

18. The processor-readable medium of claim 16, wherein the instructions cause the processor circuit to receive a participant-specific plan parameter from a database in the plans control hub module;
wherein the instructions to determine the participant-specific plan parameter include using the participant-specific plan parameter received from the database; and
wherein the instructions to apply the rules-based allocation includes using the participant-specific plan parameter received from the database.

19. The processor-readable medium of claim 16, wherein the instructions to apply the rules-based allocation to satisfy the transaction includes using a hierarchy of notional accounts having non-zero balances.

20. The processor-readable medium of claim 7, wherein the instructions to use the hierarchy of notional accounts include instructions to access notional funds from at least two or more of an incentive account, a cash-like account, or a line-of-credit account.
